(19) United States
(12) Patent Application Publication
(10) Pub. No.: US 2018/0137791 A1
(43) Pub. Date: May 17, 2018

(54) MIRROR UNIT AND DISPLAY DEVICE

(71) Applicant: OMRON Corporation, Kyoto (JP)

(72) Inventors: Yoshimasa Osumi, Kyoto (JP); Yuji Hirose, Kyoto (JP); Keiichiro Tanaka, Shiga (JP); Toshinori Yamasue, Shiga (JP)

(73) Assignee: OMRON Corporation, Kyoto (JP)

(21) Appl. No.: 15/850,706

(22) Filed: Dec. 21, 2017

Related U.S. Application Data
(63) Continuation of application No. PCT/JP2016/073688, filed on Aug. 11, 2016.

(30) Foreign Application Priority Data
Sep. 4, 2015 (JP) 2015-174796

(51) Int. Cl. G09F 19/16; G09F 13/18; G09F 19/18; B60Q 9/00; B60R 1/06; B60R 1/12

(52) U.S. Cl. CPC G09F 19/16; G09F 13/18; G09F 19/18; G09F 2013/1886; B60R 1/06; B60R 1/1207; B60Q 9/00

(57) ABSTRACT

A mirror unit includes a mirror element configured to reflect external light entering from a front surface toward the front surface, and a display device configured to show an image. The display device includes a light source configured to emit light, and a light guide element configured to guide incident light from the light source. The light guide element includes an emission surface configured to output incident light, and a plurality of light focusing portions configured to form an image outside the light guide element. The mirror element and the light guide element arranged so that the light focusing portions form an image near the front surface of the mirror element.

### BACKGROUND

### Technical Field

The present invention relates to a mirror unit that can be installed on a vehicle, and a display device configured as an implementation of the mirror unit.

### Background

Vehicle mirror units are currently being developed with built-in display devices that emit warnings to the driver. For instance, JP 2009-83631 A discloses a vehicle rear-view mirror that improves the directivity of light to display warning symbols that are easy for the driver to see, but hard for others to see. More specifically, JP 2009-83631 A improves directivity by incorporating a light-orienting tube behind a transparent glass substrate and placing an LED behind the rear end of the light-orienting tube.

### SUMMARY

However, presenting warning symbols on the mirror surface requires that the information presented can be quickly understood while driving; in that regard, existing mirror units such as the vehicle rear-view mirror unit disclosed in Patent Document 1 is limited in how it may present warnings, and could use further improvement.

Thus, one or more embodiments of the present invention provides a mirror unit capable of expanding the range of communications that may be expressed by providing a plurality of light focusing portions configured to output light that converges toward an external convergence point or convergence line, or radiates from an external convergence point or convergence line.

A display device is also provided to implement the mirror unit according to one or more embodiments of the present invention.

According to one or more embodiments of the present invention, a mirror unit is configured to be installed on a vehicle and includes: a mirror element configured to reflect external light entering from a front surface toward the front surface; and a display device configured to show an image; the display device including: a light source configured to emit light; and a light guide element configured to guide incident light from the light source; the light guide element including: an emission surface configured to output incident light; a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element; and the mirror element and the light guide element arranged so that the light focusing portions form an image near the front surface of the mirror element.

In a mirror unit according to one or more embodiments of the present invention, the light guide element is panel-like and is superposed on the mirror element at the front surface of the mirror element.

In a mirror unit according to one or more embodiments of the present invention, the mirror element a thin-film transmissive portion configured with one surface as a front surface; and a reflective layer formed on the other surface of the transmissive portion and configured to reflect external light entering from the front surface and passing through the transmissive portion; the light guide element arranged at the other surface of the mirror element.

In a mirror unit according to one or more embodiments of the present invention, a display device configured to show an image; the display device including: a light source configured to emit light; and a panel-like light guide element configured to guide incident light from the light source; and the light guide element including: an emission surface configured to output incident light; a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element; and a reflective layer formed on the surface facing the emission surface of the light guide element and configured to reflect external light entering from the emission surface and passing through the light guide element toward the emission surface.

A mirror unit according to one or more embodiments of the present invention is configured to be installed on a vehicle and includes: a display device configured to show an image; the display device including: a light source configured to emit light; and a panel-like light guide element configured to guide incident light from the light source; and the light guide element including: an emission surface configured to output incident light from the light source; a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element; and a transmissive layer formed on the surface facing the emission surface of the light guide element and configured to allow external light entering from the emission surface and passing through the light guide element to pass therethrough; and a reflective layer configured to reflect external light passing through the transmissive layer toward the emission surface.

In a mirror unit according to one or more embodiments of the present invention, the light focusing portion is configured to form light into an image that spreads in a direction other than a direction parallel to the emission surface.

In a mirror unit according to one or more embodiments of the present invention, the light focusing portion is configured to form light showing an image that indicates direction.

A mirror unit according to one or more embodiments of the present invention is provided with a plurality of light guide elements; and each of the light guide elements forms light showing a different image.

A mirror unit according to one or more embodiments of the present invention is provided with a plurality of light guide elements; and each of the light guide elements forms light showing an image indicating a different direction.

In a mirror unit according to one or more embodiments of the present invention, a single light guide element is configured with a plurality of light sources that emit light; and the plurality of light focusing portions in the light guide element includes a first light focusing group that changes the optical path of light emitted from a first light source and forms light to show a first image; and a second light focusing group that changes the optical path of light emitted from a second light source and forms light to show a second image.

In a mirror element according to one or more embodiments of the present invention, the first light focusing group and the second light focusing group each forms light showing a different image.

In a mirror element according to one or more embodiments of the present invention, the first light focusing group and the second light focusing group each forms light showing an image indicating a different direction.

A display device according to one or more embodiments of the present invention is configured to be housed in a mirror unit installed on a vehicle and includes: a light source configured to emit light; and a light guide element configured to guide incident light from the light source; the light guide element including: an emission surface configured to output incident light; and a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element.

A mirror unit according to one or more embodiments of the present invention provides a plurality of light focusing portions in a mirror configured for installation on a vehicle with the mirror unit capable of forming light to show an image.

One or more embodiments of the present invention provide a plurality of light focusing portions inside a mirror installed on a vehicle; the light focusing portions change the path of incidence light toward an emission surface causing the light to converge toward external convergence point or convergence line or to radiate from an external convergence point or convergence line to thereby form an image externally. Hereby, an image may be presented in a space separate from the mirror surface and thus provides superior benefits, such as allowing for various representations that make it possible to present information that a driver may quickly understand while driving.

### BRIEF DESCRIPTION OF THE DRAWINGS

FIG. 1 is for describing a display device according to one or more embodiments of the present invention and schematically illustrates the display device along with an image formed in a space;

FIG. 2 is a schematic view outlining a cross section of the display device according to one or more embodiments of the present invention and an optical path;

FIG. 3 is a schematic view outlining a cross section of the display device according to one or more embodiments of the present invention and an optical path;

FIG. 4(a) and FIG. 4(b) are schematic perspective views illustrating an example of the external features of a mirror unit according to one or more embodiments of the present invention and an image presented thereby;

FIG. 5 is a schematic plan view illustrating an example of a vehicle system adopting a mirror unit according to one or more embodiments of the present invention;

FIG. 6 schematically illustrates, by way of a block diagram, an example of a vehicle system adopting a mirror unit according to one or more embodiments of the present invention;

FIG. 7 is a schematic perspective view illustrating a portion of the internal structure of a mirror unit according to a first embodiment of the present invention;

FIG. 8 is a schematic front view illustrating an example of the internal structure of the mirror unit according to the first embodiment of the present invention;

FIG. 9 is a schematic cross-sectional view illustrating an example of the internal structure of the mirror unit according to the first embodiment of the present invention;

FIG. 10 is a schematic cross-sectional view illustrating an example of the internal structure of a mirror element provided to the mirror unit according to the first embodiment of the present invention;

FIG. 11 is a schematic cross-sectional view illustrating an example of the internal structure of the mirror unit according to the first embodiment of the present invention;

FIG. 12 is a schematic view illustrating an example of an optical path in a display device provided to the mirror unit according to the first embodiment of the present invention;

FIG. 13 is a schematic cross-sectional view illustrating an example of the internal structure of the mirror unit according to a second embodiment of the present invention;

FIG. 14 is a schematic cross-sectional view illustrating an example of the internal structure of the mirror unit according to the second embodiment of the present invention;

FIG. 15 is a schematic view illustrating an example of an optical path in a display device provided to the mirror unit according to the second embodiment of the present invention;

FIG. 16 is a schematic cross-sectional view illustrating an example of the internal structure of the mirror unit according to a third embodiment of the present invention;

FIG. 17 is a schematic view illustrating an example of an optical path in a display device provided to the mirror unit according to the third embodiment of the present invention;

FIG. 18 is a schematic view illustrating an example of an optical path in a display device provided to the mirror unit according to a fourth embodiment of the present invention;

FIG. 19 is for describing a display device according to a fifth embodiment of the present invention and schematically illustrates the display device along with an image formed in a space;

FIG. 20 is a schematic perspective view illustrating an example of the external features of a mirror unit according to the fifth embodiment of the present invention and an image presented thereby;

FIG. 21 is a schematic cross-sectional view illustrating an example of the internal structure of the mirror unit according to the fifth embodiment of the present invention;

FIG. 22 is a schematic cross-sectional view illustrating an example of the internal structure of a mirror unit according to a sixth embodiment of the present invention; and

FIG. 23 is a schematic cross-sectional view illustrating an example of the internal structure of a mirror unit according to a seventh embodiment of the present invention.

### DETAILED DESCRIPTION

Embodiments of the present invention are described in detail with reference to the drawings. Note that the following working examples are merely embodiments of the present invention, and in no way limit the technical character of the present invention.

Principle Behind the Display Device

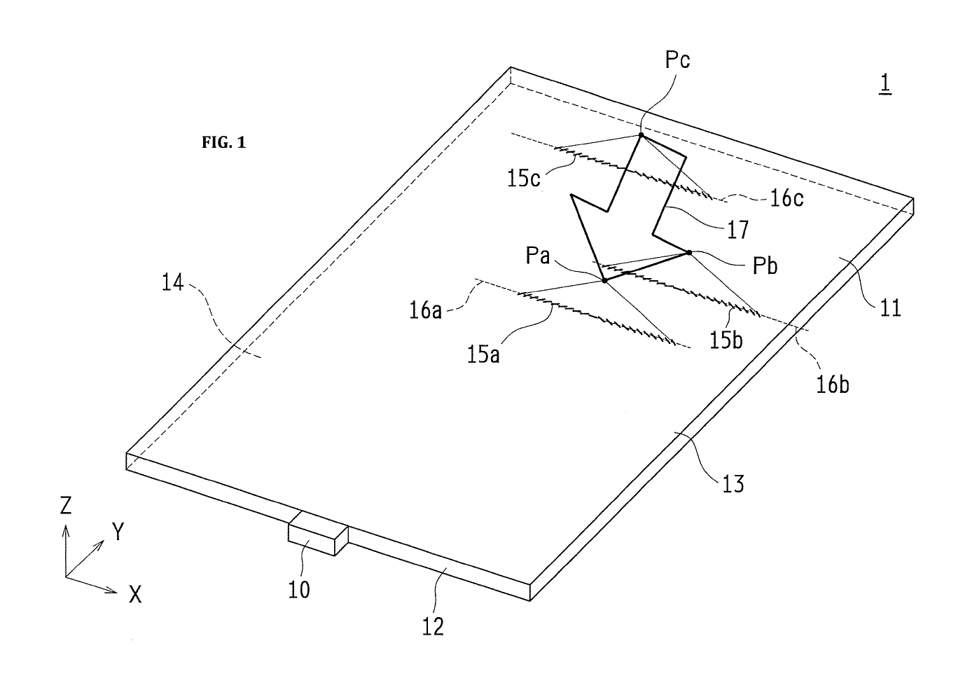

A mirror unit according to one or more embodiments of the present invention is mounted on a vehicle (e.g., a passenger car) to function as a side mirror. The built-in display device focuses light in a space separate from the mirror surface and forms an image. First, the principle of producing an image in a space described. FIG. 1 is for describing a display device according to one or more embodiments of the present invention and schematically illustrates the display device along with an image formed in a space. Note that the drawings are provided as outlines or schematic views to facilitate a simple and easy-to-understand description. There are also cases where the drawings referenced in the description contained elements that are not drawn to scale in terms of the horizontal and vertical proportions or the spaces between components.

The display device 1 is provided with a light source 10 that emits light and a light guide plate 11 (light guide element) that guides incident light entering from the light source 10. The light source 10 may be configured using a light emitting element such as an LED; light from the light source 10 enters the light guide plate 11. The light guide plate 11 may be formed from a flexible thin-film material or curable sheet into a rectangular panel-like shape using a transparent resin having a high refractive index such as a polycarbonate (PC) resin or poly methyl methacrylate (PMMA) resin, or using an inorganic material such as glass. Here, “panel like” indicates an object that is shorter (thinner) in the thickness direction (Z axis direction) than in the planar direction spreading out in two dimensions (XY plane) orthogonal to the thickness direction. That is, while the light guide plate 11 is a rectangular parallelepiped, the length thereof in the thickness direction (Z axis direction) is less than the length in a plane spreading out in two dimensions and formed by the longitudinal direction (X axis direction) and the transverse direction (Y axis direction).

The light source 10 is installed at one end surface in the longitudinal direction of the light guide plate 11. That is, one of the surfaces making up the short side of the rectangle in the thickness direction is the incidence end surface 12 where light emitted from the light source 10 enters the light guide plate 11. The light guide plate 11 causes light entering therein from the incidence end surface to spread out in planar form. The panel-like light guide plate 11 includes an emission surface configured to emit incident light entering from the light source 10 and a rear surface 14 relative to and across from the emission surface 13.

In the description that follows, the rectangular coordinate system, and in particular the right-handed system of x axis, y axis, and z axis is used as necessary. The X axis is the transverse direction of the light guide plate 11, i.e., the direction along the short side of the rectangle. The Y axis is the longitudinal direction of the light guide plate 11, i.e., the direction along the long side of the rectangle, where the direction from the incidence end surface 12 toward the end surface facing the incidence end is the positive direction. The Z axis is the thickness direction of the light guide plate 11, where the direction from the rear surface 14 to the emission surface 13 is the positive direction. The light guide plate 11 may be used in a non-planar way, e.g., may be bent for use. In this case, the surface including the main portion of the emission surface 13 or a neighboring surface may be used as a reference for the X axis, Y axis, and Z axis.

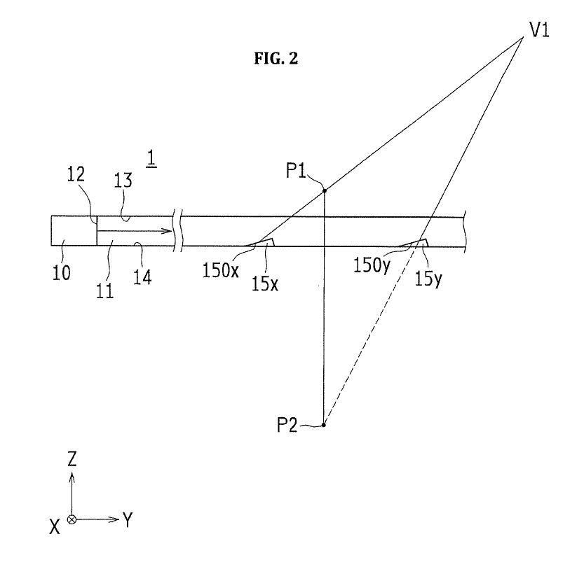

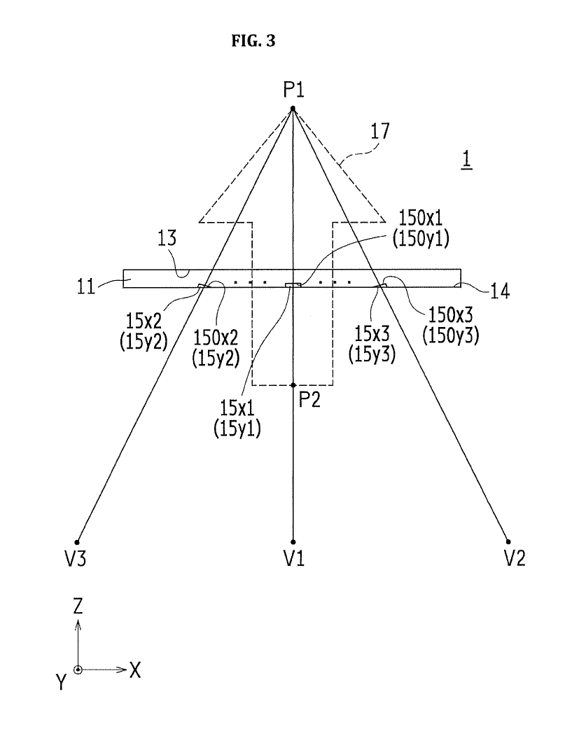

A plurality of light focusing portions 15 is formed on the rear surface 14 of the light guide plate 11; the light focusing portions 15 are represented as light focusing portions 15a, 15b, 15c, . . . in the drawings. The light focusing portions 15 are situated along the progressive path of incident light entering from the incidence end surface; that is, the light focusing portions 15 adjust the optical path of the incident light toward the emission surface 13. Here, the light focusing portions 15 are illustrated as optical surfaces formed inside the light guide plate 11, and in this particular case, as reflection surfaces 150 (FIG. 2: 150x, 150y; and FIG. 3: 150x1, 150x2, 150x3) that reflect incident light entering from the incidence end surface 12. Oblique notches may be cut into the rear surface 14 with the inclined surfaces serving as the reflection surfaces 150. The reflection surfaces 150 of the light focusing portions 15 are formed as substantially continuous in the X axis direction. More specifically, the plurality of light focusing portions 15a fall along a line 16a, the plurality of light focusing portions 15b fall along a line 16b, and the plurality of light focusing portions 15c fall along a line 16c. The other light focusing portions 15 (not shown) are formed in the same manner. Here the lines 16 (lines 16a, 16b, 16c, . . . ) are virtual straight lines extending substantially parallel to the X axis on the rear surface 14. Any given light focusing portion 15, 15, . . . is formed as substantially continuous along a straight line 16 that is substantially parallel to the X axis direction. The light entering the light guide plate 11 is guided toward the light focusing portions 15, 15, . . . lined up along the X axis direction.

The light focusing portions 15 include components such as the reflection surfaces 150 for changing the optical path. The reflection surface 150 in a light focusing portion 15 changes the path of incident light causing the light to exit from the emission surface 13 and substantially converge at convergence point P corresponding to the light focusing portion 15. FIG. 1 depicts a portion of the light focusing portions 15, namely, light focusing portions 15a, 15b, 15c, . . . ; more specifically, FIG. 1 depicts the plurality of light rays with paths changed by each of the light focusing portions 15a, 15b, 15c, . . . converging at convergence points Pa, Pb, Pc respectively. Each of the light focusing portions 15 cause the light rays to converge at convergence points P to form an image, thus forming an image 17.

More specifically, the plurality of light focusing portions 15 on any one of the lines 16a, 16b, 16c, . . . may correspond to a convergence point P in the image 17. The plurality of light focusing portions 15 in any given line 16 may change the optical path of the light rays emanating from the positions of the light focusing portions 15 when light reflects from the optical surfaces of, e.g., the reflection surfaces 150; hereby the light rays exit from the emission surface 13 and converge at a convergence point P. Therefore, the wavefront of light from the plurality of light focusing portions 15 becomes a wavefront that appears to radiate from the convergence point P. For example, the plurality of light focusing portions 15a on the line 16a correspond to a convergence point Pa in the image 17. The light focusing portions 15a change the optical path of the light rays guided toward the plurality of light focusing portions 15a on the line 16a, and thus the light rays exit from the emission surface 13 and converge at the convergence point Pa. Light reflected by the plurality of light focusing portions 15 along other lines 16 converges identically at convergence points P. Thus, any desired light focusing portion 15 can provide a wavefront of light so that light appears to radiate from the corresponding convergence point P. The convergence points P correspond to mutually different light focusing portions 15. A grouping of a plurality of convergence points P that correspond to each of the light focusing portions 15 produces a recognizable image 17 in a space. The display device 1 thus projects the image 17 as a three-dimensional image in a space. The image 17 depicted in FIG. 1 is drawn as a three-dimensional image with lines; the lines used to draw the image 17 are produced by grouping a plurality of convergence points P corresponding to each of the light focusing portions 15.

The display device 1 forms an image with light exiting from the emission surface 13 to produce the image 17 as a spectroscopic image. The image 17 is a spectroscopic image that may be recognized in a space by an observer. Note that, in this specification, the term spectroscopic image refers to an image 17 that appears to be at a location that is different from the emission surface 13 external to the display device 1. The term spectroscopic image is not limited to a three-dimensional image and includes a two-dimensional image perceived at a location separate from the efficient surface 13 of the display device 1, for instance. In other words, the term “spectroscopic image” does not refer only to an image perceived as having a solid shape, but also includes the image 17 in two-dimensional form perceived at a different location than on emission surface 13 of the display device 1 and represents an image 17 that appears to be protruding from the light guide plate 11 of the display device 1.

The light guided by the light guide plate 11 is oriented in a direction connecting locations in the light guide plate 11 and the light source 10 while not including a spread component orthogonal to a direction connecting locations in the light guide plate 11 and the light source 10. The light focusing portions 15 may be provided at locations separated from the light source 10; in this case, the light guided by the light guide plate 11 is oriented generally towards the Y axis direction from the location at which the light focusing portion is provided but does not spread in the X axis direction. Therefore, the light from the light focusing portion 15 substantially converges onto a single convergence point P in a plane parallel to the XZ plane that includes the convergence point P.

When the light entering light focusing portions 15 spread in the Z axis direction, the light from the light focusing portions 15 converge on a convergence line along the Y axis in a space containing the convergence point P. However, the description of the embodiment focuses on the convergence of light in the XZ plane to facilitate understanding of the embodiment and describes the same as light from the light focusing portions 15 converging on the convergence points P.

FIG. 2 and FIG. 3 are schematic views outlining a cross section of the display device 1 according to one or more embodiments of the present invention and an optical path. FIG. 2 illustrates a cross-section parallel to the YZ plane, and FIG. 3 also illustrates the image 17 viewed by an observer of a cross-section parallel to the XZ plane. FIG. 2 and FIG. 3 illustrates not only the emission surface 13 of the light guide plate 11 (i.e., the positive Z axis direction), but also provides an example of the image 17 representing an arrow that also spreads at the rear surface 14 (negative Z axis direction) In the example illustrated in FIG. 2 and FIG. 3, the image 17 which represents an arrow appears with the front portion of the arrow protruding from the emission surface 13 and the rear portion of the arrow protruding from the rear surface 14.

As illustrated in FIG. 2, the light source 10 is installed at the incidence end surface 12 of the light guide plate 11, and the incidence end surface 12 and the emission surface 13 are substantially orthogonal. Additionally, the rear surface 14 faces the emission surface 13, and the rear surface 14 is also substantially orthogonal to the incidence end surface 12. The rear surface 14 is a flat surface substantially parallel to the emission surface 13 and is provided with inclined surfaces that form the reflection surfaces 150 (150x, 150y) of the light focusing portions 15. The flat rear surface 14 along with the emission surface 13 guides the incident light entering the light guide plate 11 from the incidence end surface 12 via total internal reflection therebetween and function to spread the light in the light guide plate in planar form. The inclined reflection surfaces 150 of the light focusing portions 15 reflect the incident light entering the light guide plate 11 to thereby adjust the optical path of the light toward the emission surface 13.

That is, the light emitted from the light source 10 and entering the light guide plate 11 from the incidence end surface 12 is repeatedly totally reflected between the emission surface 13 and the rear surface 14 within the light guide plate 11 and propagates therethrough in planar form. On arriving at a reflection surface 150 formed in the light focusing portion 15, the light propagating through the light guide plate 11 is reflected by the reflection surface 150 and exits to the outside from the emission surface 13.

As illustrated in FIG. 2 and FIG. 3, the plurality of light focusing portions 15x (light focusing portions 15x1, 15x2, 15x3, . . . ) located on a line 16 include reflection surfaces 150x1, 150x2, 150x3, . . . , respectively. The reflection surfaces 150x1, 150x2, 150x3, . . . corresponding to the plurality of light focusing portions 15x located along the line 16 reflect light toward the emission surface 13 toward a direction converging at a convergence point P1 near the emission surface 13. A plurality of light focusing portions 15y (light focusing portions 15y1, 15y2, 15y3, . . . ) is located on another line 16 and also include reflection surfaces 150y1, 150y2, 150y3, . . . , respectively. The reflection surfaces 150y1, 150y2, 150y3 corresponding to the plurality of light focusing portions 15y located along the other line 16 reflect light toward the emission surface 13 toward a direction where the light radiates from a convergence point P2 near the rear surface 14. Therefore, the incline of the reflection surface 150y2 of the light focusing portion 15y2 and the reflection surface 150y3 of the light focusing portion 15y2 (written in parenthesis in FIG. 3) are the opposite direction in FIG. 3 and are inclined toward the end surface of the light guide plate 11.

The reflection surfaces 150x (e.g., the reflection surfaces 150x1, 150x2, 150x3, . . . ) each reflects light from the light source 10 in a direction along a line connecting a point on each of the reflection surfaces 150x and the convergence point P1. The light rays reflected from the reflection surfaces 150x converge at the convergence point P1. Thus, the plurality of reflection surfaces 150x in corresponding light focusing portions 15x reflects incident light entering from the light source 10 in a direction along a line connecting a point on each of the reflection surfaces 150x and the convergence point P1. Therefore, the display device 1 can supply light from the convergence point P1 oriented toward any of the positions in a range from a position V2 through a position V1 and up to position V3. A convergence point P1 of this kind produces the image 17 which appears to protrude from near the emission surface 13.

The reflection surfaces 150y (e.g., the reflection surfaces 150y1, 150y2, 150y3) each reflects incident light entering from the light source 10 in a direction along a line connecting a point on each of the reflection surfaces 150y and the convergence point P2. The light rays reflected from the reflection surfaces 150y may be extended in a direction opposite the direction the light rays travel, in which case the extension line from the light rays converge at the convergence point P2. Thus, the plurality of reflection surfaces 150y in corresponding light focusing portions 15y reflects incident light entering from the light source 10 in a direction along a line connecting a point on each of the reflection surfaces 150y and the convergence point P2. Therefore, the display device 1 can supply light from the convergence point P2 oriented toward any of the positions in a range from a position V2 through a position V1 and up to position V3. A convergence point P2 of this kind produces the image 17 which appears to protrude from the opposite side of emission surface 13 (i.e., near the rear surface 14).

As above described, the light guide plate 11 includes a plurality of light focusing portions 15 having mutually different convergence points P, where a grouping of a plurality of convergence point P including a convergence point P1 and a convergence point P2 produces an image 17 that serves as a stereoscopic image. That is, the light guide plate 11 is provided with a plurality of light focusing portions 15 which change the path of incidence light toward an emission surface 13 causing the light output to converge toward an external convergence point or convergence line or to radiate from an external convergence point or convergence line and thereby form an image externally. By grouping a plurality of convergence point P and convergence lines, the display device 1 can thus form an image 17 outside the light guide plate 11 that can be perceived by an observer as a stereoscopic image.

In other words, the following kinds of statements can be made. Light emitted from a light source 10 enters a light guide plate 11, and the light guide plate 11 guides light within a plane parallel to the emission surface 13. A plurality of light focusing portions 15 is formed on the light guide plate 11; the light focusing portions 15 lengthen in a direction (i.e., the X axis direction) orthogonal to the direction in which the light guide plate guides light within a plane parallel to the emission surface 13 (Y axis direction). Each of the light focusing portions 15 includes optical surfaces where the direction of the normal line thereof projected onto a surface parallel to the emission surface varies continuously or gradually along the length direction of the light focusing portions 15 (X axis direction). The light guided by the light guide plate 11 reflects from the optical surfaces whereby the light exits as emission light from the emission surface 13 in a direction to substantially converge on a single convergence point P or convergence line in a space, or to substantially radiate from a single convergence point P or convergence line. The convergence points P or convergence lines are mutually different for the plurality of light focusing portions 15 at different positions along the Y axis, and grouping a plurality of convergence points P or convergence lines produces an image 17 in a space.

FIG. 2 and FIG. 3 and the corresponding descriptions illustrate a stereoscopic image that appears to protrude from both the emission surface 13 and the rear surface 14; this is used to describe the basic principles behind producing a stereoscopic image. However, as illustrated in FIG. 1 the stereoscopic image may appear to protrude from near only one surface.

The reflection surfaces 150 here serve as the light focusing portions 15. However, the light focusing portions 15 can have various forms so long as the light focusing portions can change the path of incident light traveling through the light guide plate 11. For instance, the light focusing portion 16 may be formed as a cylindrical Fresnel lens, whereby the refraction effect of the refraction surface of the Fresnel lens (i.e., the prism surface) changes the path of the incident light. Additionally, in this case the Fresnel lens may be constituted by a plurality of parts with gaps therebetween. The light focusing portions 15 may also be formed as a diffraction grating whereby the diffraction effect may change the path of the incident light. Moreover, the reflection effect and the refraction effect of the prism may change the path of the incident light.

Additionally, the distances between all the convergence points P and emission surface 13 may be non-uniform. In this case, the density of converging light is configured to increase as the distance from the emission surface 13 increases when forming an image 17 that spreads for instance three dimensionally, or when forming a two-dimensional image 17 that contains a plane obliquely intersecting the emission surface 13. Hereby, any blurring in the image 17 formed is substantially uniform, making it possible to create an image 17 that does not make the observer uneasy.

Furthermore, while the light emitted from the light source 10 is represented as incident light entering the light guide plate 11 from the incidence end surface 12 which is one in surface in the longitudinal direction of the light guide plate 11, the incident light is not limited thereto. For example, the rear surface 14 may be taken as the light incidence surface and appropriately designed so that light enters the light guide plate therefrom.

Application to Automotive Systems

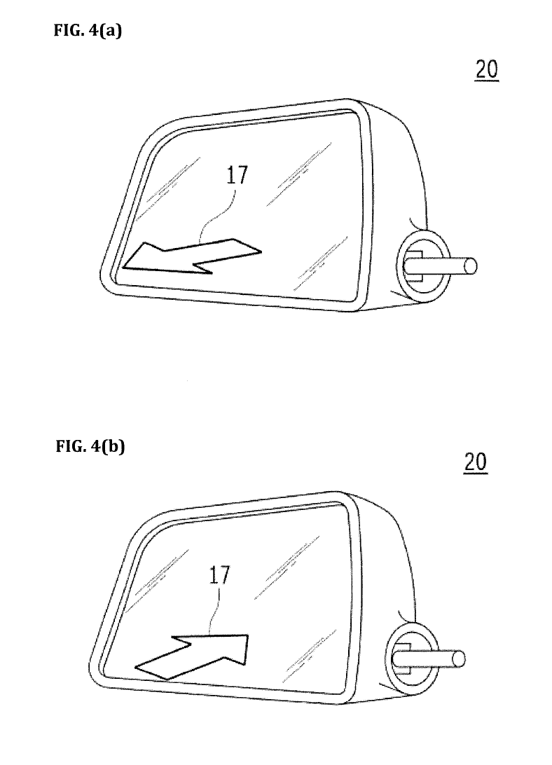

An example is described where a mirror unit provided with the above configured display device 1 is adopted in an automotive system. FIG. 4(a) and FIG. 4(b) are schematic perspective views illustrating an example of the external features of a mirror unit according to one or more embodiments of the present invention and an image 17 presented thereby. FIG. 4(a) and FIG. 4(b) illustrate a mirror unit 20 mounted as a side mirror on a vehicle such as a vehicle 2 (FIG. 5). The mirror unit 20 depicted in FIG. 4(a) and FIG. 4(b) is provided with a display device 1 configured from two overlapping light guide plates 11; each of the light guide plates 11 forms light showing a different image 17. The image 17 displayed is a stereoscopic image representing the direction of an arrow. FIG. 4(a) depicts an image 17 pointing to the rear of the vehicle 2; and FIG. 4(b) depicts an image 17 to in front of the vehicle 2. Both of the images 17 depict an arrow indicating the front or the rear of the vehicle 2 and are stereoscopic images appearing to protrude from the mirror surface of the mirror unit 20. Ordinarily, when the arrow appears on the mirror surface of the side mirror, even an arrow showing the front or the rear is represented by an arrow oriented up or down. In contrast, the mirror unit 20 provided to the display device 1 according to one or more embodiments of the invention is capable of forming a stereoscopic image that spreads in a direction not parallel to the mirror surface; therefore, the tip of the arrow in the image 17 is oriented toward the front or the rear when presented. Conceivably, the most likely observer of the image 17 displayed, i.e., the driver of the vehicle 2, would be able to more quickly recognize the front or rear direction from an arrow indicating the front or rear direction rather than recognizing the front or rear direction from an arrow indicating the up and down directions. Therefore, the mirror unit 20 according to one or more embodiments of the present invention provides superior benefits such as making it possible to present information that a driver may recognize quickly while driving.

FIG. 5 is a schematic plan view illustrating an example of a vehicle system adopting a mirror unit according to one or more embodiments of the present invention. FIG. 5 is a top view of a vehicle 2 where the mirror unit 20 according to one or more embodiments of the present invention is adopted in the automotive system. The vehicle 2 is provided with vehicle sensors 3 at the left front end, the right front end, the left rear end, and the right rear end. The vehicle sensors 3 can detect approaching vehicles as detection objects outside the car. The description here are vehicle sensors 3, however various objects, which may collide with the vehicle, such as people and obstacles may be taken as detection objects.

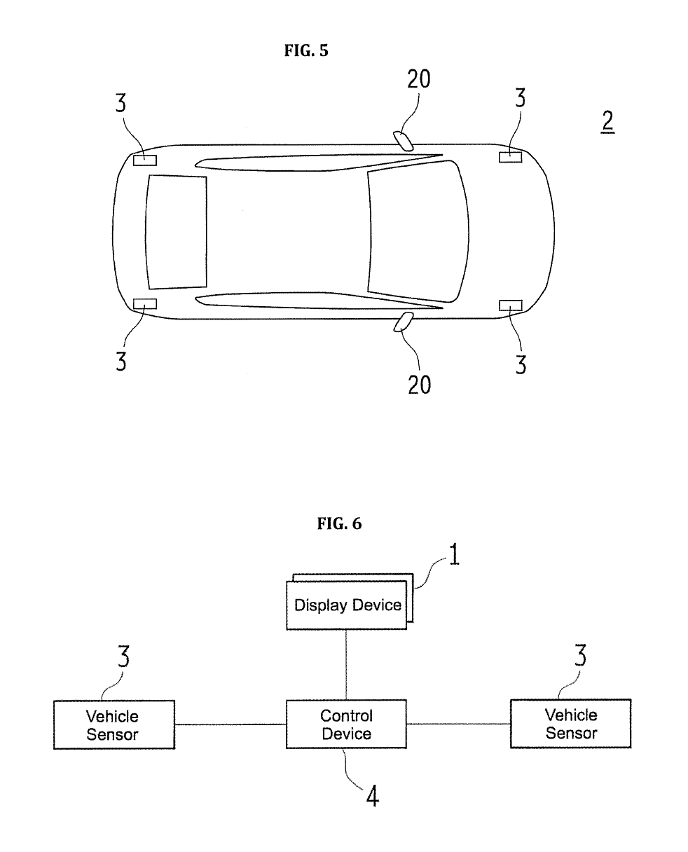

FIG. 6 schematically illustrates, by way of a block diagram, an example of a vehicle system adopting the mirror unit 20 according to one or more embodiments of the present invention. The vehicle 2 is provided with a control device 4 such as an electronic control device (electric control unit, ECU) which controls the display device 1 provided to the mirror unit 20. The control device 4 is connected to the vehicle sensors 3 placed at the left front end and the rear front end of the vehicle 2. The vehicle sensor 3 transmits a detection signal to the control device 4 on detecting a detection object such as a nearby vehicle. The control device 4 maps the light sources 10 provided to each of the two light guide plates 11 in the display device 1 and the front and rear vehicle sensors 3 to each other in advance and manages the same; on receiving a detection signal from a vehicle sensor 3 the control device 4 transmits and emission command signal to the light source preliminarily mounts to the vehicle sensor 3 originating the detection signal. The light source 10 receiving the emission command signal emits light, and the light guide plate 11 installed in the emitting light source 10 displays an image 17 of an arrow showing a direction. Thus, the mirror unit 20 is able to display an image 17 of an arrow pointing to the front when a vehicle is detected toward the front, and an image 17 of an arrow pointing to the rear when a vehicle is detected toward the rear. Note that what is described here is a left side control system in a right-hand drive vehicle where it is difficult for a driver to understand what is happening on the left side of the vehicle. However, the control system is identical for the right side. The mirror unit 20 according to one or more embodiments of the present invention may be adopted in an automotive system which is installed as a part of a vehicle LAN that integrates the electronic control units inside the vehicle 2.

A mirror unit 20 that may be mounted in this kind of automotive system and is also capable of displaying a plurality of stereoscopic images may take many forms. Embodiments of the various internal structures possible for implementing the mirror unit 20 are described.

### First Embodiment

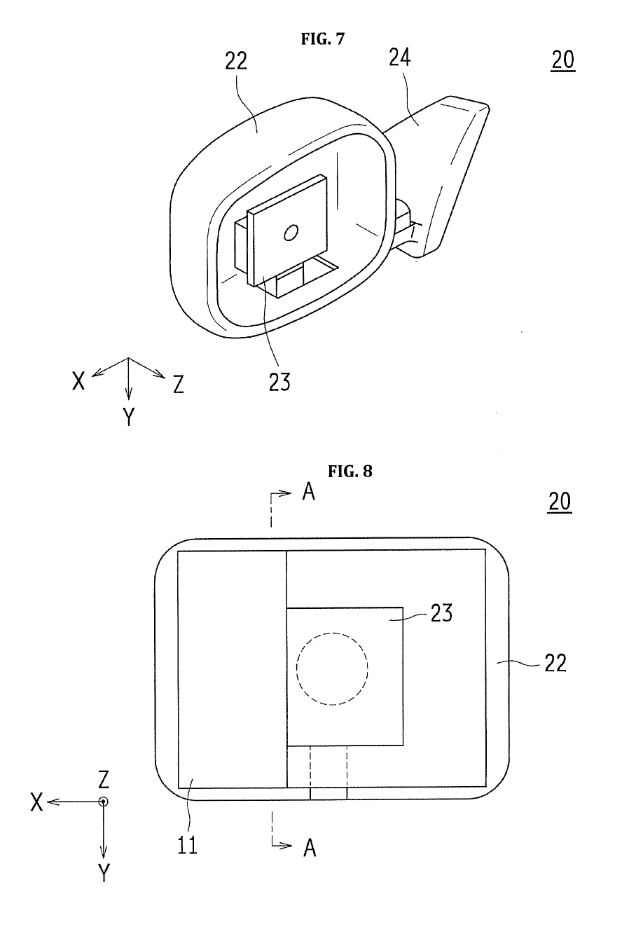

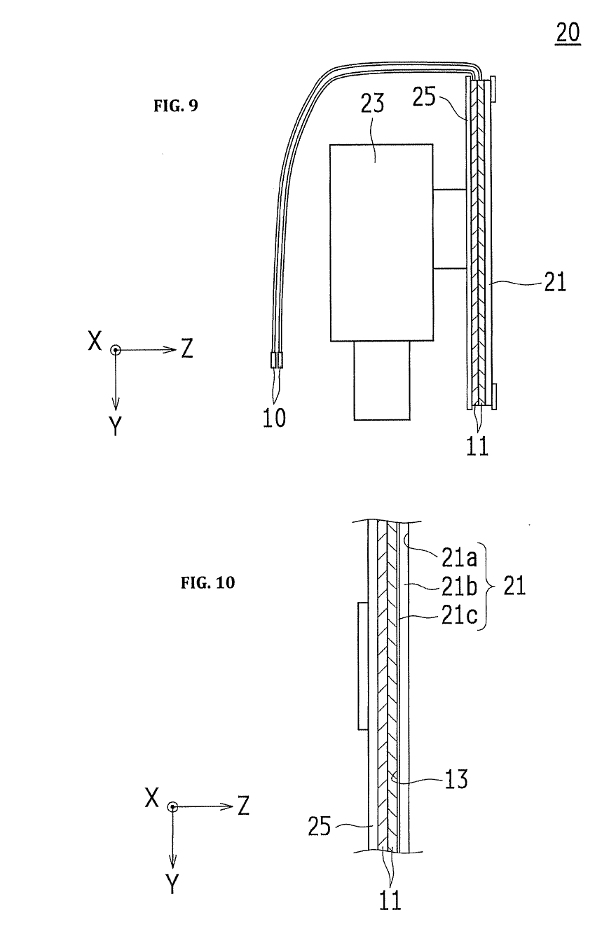

FIG. 7 is a schematic perspective view illustrating a portion of the internal structure of a mirror unit according to a first embodiment of the present invention; FIG. 8 is a schematic front view illustrating an example of the internal structure of the mirror unit according to the first embodiment of the present invention; FIG. 9 is a schematic cross-sectional view illustrating an example of the internal structure of the mirror unit according to the first embodiment of the present invention; and FIG. 10 is a schematic cross-sectional view illustrating an example of the internal structure of a mirror element provided to the mirror unit according to the first embodiment of the present invention. FIG. 7 excludes some portions of the mirror unit 20 such as the display device 1 which is the mirror, and the mirror element 21 to show the inside of the mirror unit. The descriptions of the mirror unit 20 assume the direction in which the mirror element 21 is arranged is the front surface. In order for the display device 1 to emit light toward the front of the mirror element 21, the front part of the mirror element 21 is along the positive Z axis direction. FIG. 8 is a front view illustrating through the mirror element 21 to the internal structure of the mirror unit 20; FIG. 9 and FIG. 10 illustrate the internal structure of the mirror unit 20 from the cross-sectional view along A-A in FIG. 8. FIG. 9 also illustrates the arrangement inside the mirror unit 20, and FIG. 10 is an exploded view of the components making up the mirror element 21.

The mirror unit 20 is provided with a housing 22 that stores the display device 1, and the various parts of the mirror element 21. The front plane of the housing 22 is open and the rim includes a gap which, when the mirror element 21 is fitted to the housing 22, allows the mirror element 21 to block the opening. The housing 22 is provided with a drive mechanism 23 capable of changing the angle of the mirror element 21; the mirror element is secured to the drive mechanism 23. The housing 22 may also be installed on the vehicle 2 by way of an attachment 24; the attachment 24 contains various kinds of communication wiring for connecting the various electrical components in the mirror unit 20 such as the light source 10 of the display device 1 and the drive mechanism 23 to units in the vehicle 2 such as the control device 4. The driver may manipulate various operational input buttons arranged near the driver seat which operates the drive mechanism 23 and adjusts the angle of the mirror element 21.

A fastener frame 25 acts as a border inside the housing 22 and secures the light guide plate 11 and the mirror element 21 to the drive mechanism 23; the light guide plate 11 and the mirror element 21 are housed within the fastener frame 25 and thereby blocks the opening in the front surface of the housing. The fastener frame 25 includes a fastening panel at the rear so that securing the fastening panel to the drive mechanism 23 fastens the light guide plate 11 and mirror element 21 housed within the fastener frame 25 to the drive mechanism 23. Two light sources 10 for the display device 1 are also arranged inside the housing 22 behind the drive mechanism 23. The two flexible, thin-film light guide plates 11 to which the two light sources 10 are respectively attached are inserted into the fastener frame 25 of the mirror element 21 from above. The tip ends of the light guide plates 11 reach the lower portion of the fastener frame 25. The light guide plates 11 pass the drive mechanism 23 laterally and arranged at the side of the mirror element 21 so that the light guide plates 11 do not interfere with the function of the drive mechanism 23.

The two light guide plates 11 are overlapped behind the mirror unit 21 inside the fastener frame 25. The mirror element 21 and the light guide plates 11 may be securely adhered to the fastener panel as necessary with an adhesive agent. The mirror element 21 is provided a transmissive portion 21b, a front surface 21a in front of the transmissive portion 21b, and a reflective layer 21c behind the transmissive portion 21b. Light enters the mirror element 21 through the front surface 21a, passes through the transmissive portion 21b and reflects from the reflective layer 21c. The transmissive portion 21b may be produced using a resin material such as transparent polycarbonate resin or poly methyl methacrylate resin, or an inorganic material such as glass. The reflective layer 21c may be a metal-plated or vapor-deposited layer produced by plating or depositing a metal such as aluminum or silver. The reflective layer 21c reflects light entering from the front surface 21a of the mirror element 21 whereby the mirror element 21 functions as a mirror.

Thus, the mirror unit 20 according to the first embodiment of the present invention is made up of two light guide plates 11 overlapped behind a mirror element 21. More specifically, the mirror element 21 and the two light guide plates 11 behind the mirror element 21 are stacked so that the respective panel-like surfaces are parallel. In other words, the mirror element 21 is a thin panel-like component provided with a transmissive portion 21b, a front surface 21a as one surface on the front part of the transmissive portion 21b, and a reflective layer 21c as the other surface on the rear part of the transmissive portion 21b. Light enters the mirror element 21 through the front surface 21a, passes through the transmissive portion 21b and reflects from the reflective layer 21c. Additionally, the plurality of light guide plates 11 are overlapped at the other surface of the mirror element 21. Note that in the first embodiment of the present invention the mirror element 21 and the two light guide plates 11 behind the mirror element 21 may be modified in various ways so long as the panel-like portion thereof are parallel when superposed over each other.

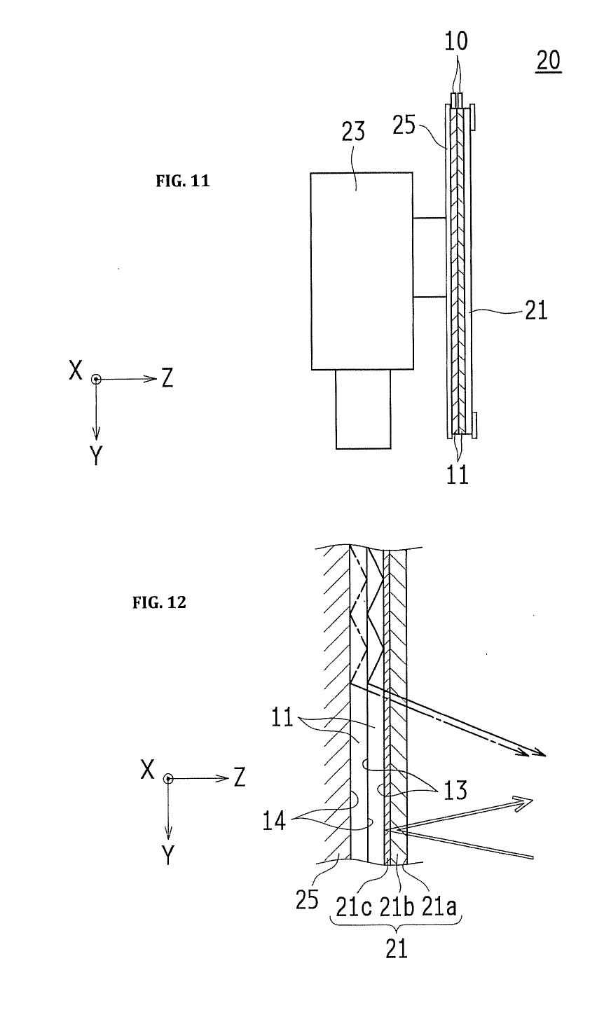

FIG. 11 is a schematic cross-sectional view illustrating an example of the internal structure of the mirror unit 20 according to the first embodiment of the present invention; FIG. 11 is a cross-sectional view showing a modification example of the mirror unit 20 according to the first embodiment. In FIG. 11 the two light sources 10 of the display device 1 are arranged at the top part of the mirror element 21, with each of the light sources 10 attached to a light guide plate 11 which extends downward. The light guide plates 11 are positioned behind the mirror element 21. When implemented thus, the light guide plates 11 may be produced from a hardened material and not flexible.

The optical functions of the first embodiment of the present invention thusly configured are described. FIG. 12 is a schematic view illustrating an example of an optical path in a display device provided to the mirror unit 20 according to the first embodiment of the present invention. FIG. 12 superimposes a schematic cross-sectional view of the display device 1 according to the first embodiment; here, solid and dotted arrows represents the optical path of light emitted from the light source 10, while double lines represent the path of external light entering from outside. Light emitted from a light source 10 enters the light guide plate 11 from above. The light guide plate 11 guides the incident light entering from the light source 10 so that the light is repeatedly totally reflected between the emission surface 13 on the rear surface 14 as the 11; the light is reflected from the light focusing portions 15 (omitted from FIG. 12), and exits from the emission surface 13. The light emitted from the light emission surface 13 of the light guide plate 11 passes through the mirror element 21 forms an image outside the mirror unit 20 and produces a stereoscopic image presenting a direction such as an arrow. Note that the light emitted from the rear light guide plate 11 represented by the dashed line passes through the other light guide plate 11 superposed in front and then passes through the mirror element 21.

The mirror element 21 functions as a mirror by causing external light to enter through the front surface 21a, pass through the transmissive portion 21b, and reflect from reflective layer 21c to pass through the front surface 21a to the outside. Given that the light guide plate 11 does not affect the light entering from outside, the image 17 will not be distorted on reflection from the mirror element 21.

The first embodiment thusly configured uses a display device 1 provided with two light guide plates 11 in a mirror unit 20 to present a stereoscopic image in accordance with an external signal, the stereoscopic image oriented towards the front or rear i.e., an actual direction, and in other words an arrow representing the direction responses to the location of an obstacle such as another vehicle that is approaching. The mirror element 21 housed in the mirror unit 20 is arranged in front of the light guide plates 11; therefore, the image 17 reflected by the mirror element 21 does not give rise to certain phenomena such as distortion due to effects from the light guide plates 11.

### Second Embodiment

The second embodiment switches the locations of the light guide plates 11 and the mirror element 21 of the first embodiment. Given that only the location of the light guide plates 11 and the mirror element 21 changes in the second embodiment and all other configurations are identical to the first embodiment, it is sufficient to reference the first embodiment for these configurations as further descriptions thereof are omitted. The identical parts in the first and second embodiments are given and the same reference numerals.

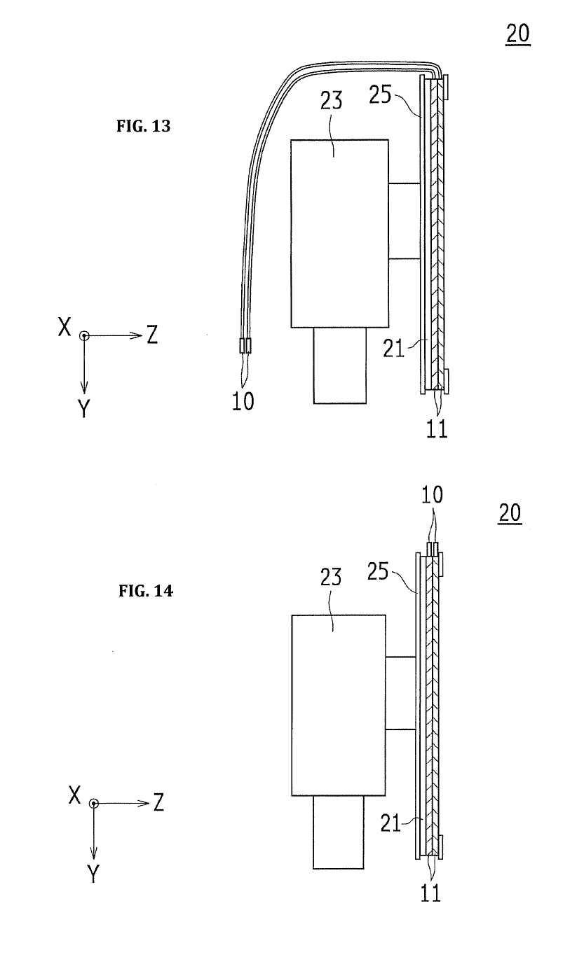

FIG. 13 is a schematic cross-sectional view illustrating an example of the internal structure of the mirror unit according to a second embodiment of the present invention. In the second embodiment, two light sources 10 for the display device 1 are arranged inside the housing 22 behind the drive mechanism 23. The two flexible, thin-film light guide plates 11 to which the two light sources 10 are respectively attached are inserted into the fastener frame 25 of the mirror element 21 from above. The tip ends of the light guide plates 11 reach the lower portion of the fastener frame 25. The light guide plates 11 pass the drive mechanism 23 laterally and arranged at the side of the mirror element 21 so that the light guide plates 11 do not interfere with the function of the drive mechanism 23. In contrast to the first embodiment, the two light guide plates 11 are overlapped in front of the mirror unit 21 inside the fastener frame 25.

Thus, the mirror unit 20 according to the second embodiment of the present invention is made up of two light guide plates 11 overlapped in front of a mirror element 21. More specifically, the mirror element 21 and the two light guide plates 11 in front of the mirror element 21 are stacked so that the respective panel-like portions are parallel. In other words, the mirror element 21 is a thin panel-like component provided with a transmissive portion 21b, a front surface 21a as one surface on the front part of the transmissive portion 21b, and a reflective layer 21c as the other surface on the rear part of the transmissive portion 21b. Light enters the mirror element 21 through the front surface 21a, passes through the transmissive portion 21b and reflects from the reflective layer 21c. Additionally, the plurality of light guide plates 11 are overlapped where the front surface 21a of the mirror element 21 reflects light. Note that in the second embodiment of the present invention the mirror element 21 and the two light guide plates 11 in front of the mirror element 21 may be modified in various ways so long as the panel-like portions thereof are parallel when stacked.

FIG. 14 is a schematic cross-sectional view illustrating an example of the internal structure of the mirror unit 20 according to the second embodiment of the present invention. FIG. 14 is a schematic cross-sectional view illustrating a modification example of the mirror unit 20 according to the second embodiment. In FIG. 14 the two light sources 10 of the display device 1 are arranged at the top part of the mirror element 21, with each of the light sources 10 attached to a light guide plate 11 which extends downward. The light guide plates 11 are positioned in front of the mirror element 21. When implemented thus, the light guide plates 11 may be produced from a hardened material and not flexible.

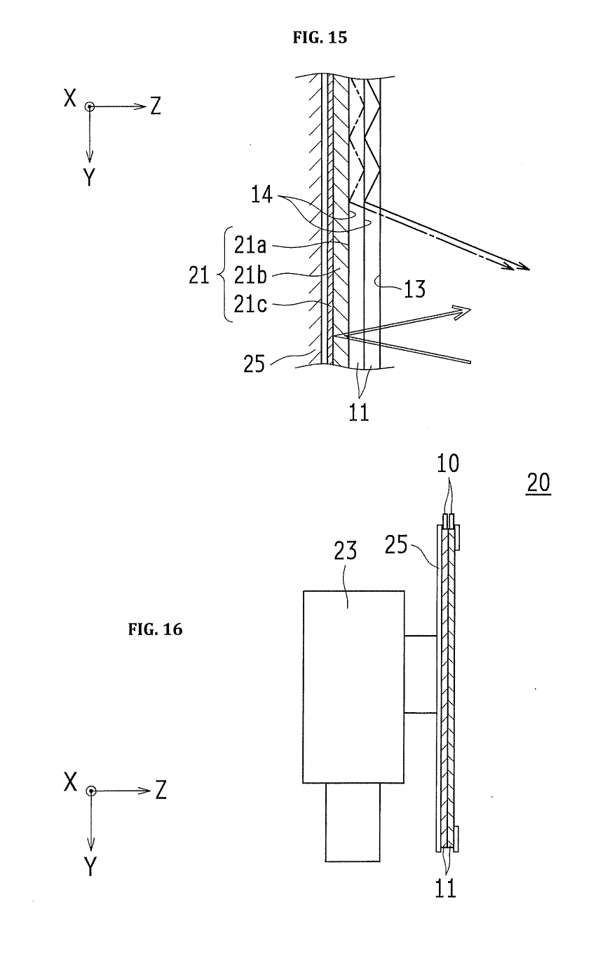

The optical functions of the second embodiment of the present invention thusly configured are described. FIG. 15 is a schematic view illustrating an example of an optical path in a display device 1 provided to the mirror unit 20 according to the second embodiment of the present invention. FIG. 15 superimposes a schematic cross-sectional view of the display device 1 according to the second embodiment; here, solid and dotted arrows represents the optical path of light emitted from the light source 10, while double lines represent the path of external light entering from outside. Light emitted from a light source 10 enters the light guide plate 11 from above. The light guide plate 11 guides the incident light entering from the light source 10 so that the light is repeatedly totally reflected between the emission surface 13 on the rear surface 14 as the 11; the light is reflected from the light focusing portions 15, and exits from the emission surface 13. The light emitted from the light emission surface 13 of the light guide plate 11 forms an image outside the mirror unit 20 and produces a stereoscopic image presenting a direction such as an arrow. Note that the light emitted from the rear light guide plate 11 passes through the other light guide plate 11 superposed in front and then forms an image outside the mirror unit 20. Additionally, the image 17 resulting from image formation does not need to pass through the reflective layer 21c of the mirror element 21, and thus allows the display device 1 according to the second embodiment to present a bright image 17.

The mirror element 21 functions as a mirror by allowing the external light transmitted through the two light guide plates 11 to enter through the front surface 21a, pass through the transmissive portion 21b and reflect from the reflective layer 21c to pass through the two light guide plates 11 and exit to the outside. The light reflected by the mirror element 21 is transmitted through the light guide plates 11. However, the surface area of the reflection surfaces of the light focusing portions 15 (i.e., the number of reflection surfaces) may be smaller than the surface area of the front surface 21a. This configuration allows the mirror element 21 to function as a mirror and additionally keep the distortion of the image reflected therefrom at a level unrecognizable to an observer.

The second embodiment thusly configured uses a display device 1 provided with two light guide plates 11 in a mirror unit 20 to display a stereoscopic image in accordance with an external signal, the stereoscopic image oriented towards the front or rear i.e., an actual direction, and in other words an arrow representing the direction responses to the location of an obstacle such as another vehicle that is approaching. The light guide plates 11 housed in the mirror unit 20 is arranged in front of the mirror element 21; therefore, the image 17 produced via image formation by the light guide plate 11 is bright when presented. Moreover, a suitable design of the light focusing portions 15 provided to the display device 1 makes it possible for the mirror element to function as a mirror as well as keep the distortion of the image reflected therefrom at a level unrecognizable to an observer.

### Third Embodiment

The third embodiment uses the light guide plates 11 in the display device 1 provided to the mirror unit 20 as a mirror element 21. Given that only the light guide plates 11 and the mirror element 21 are different in the third embodiment and all other configurations are identical to the first embodiment, it is sufficient to reference the first embodiment for these configurations as further descriptions thereof are omitted. The identical parts in the first and third embodiments are given and the same reference numerals.

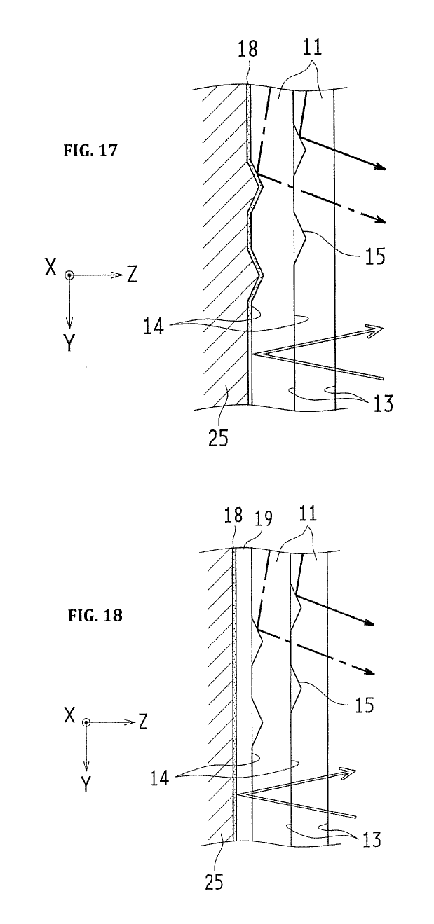

FIG. 16 is a schematic cross-sectional view illustrating an example of the internal structure of the mirror unit 20 according to a third embodiment of the present invention; and FIG. 17 is a schematic view illustrating an example of an optical path in a display device 1 provided to the mirror unit 20 according to the third embodiment of the present invention. FIG. 17 superimposes a schematic cross-sectional view of the display device 1 according to the third embodiment; here, solid and dotted arrows represents the optical path of light emitted from the light source 10, while double lines represent the path of external light entering from outside.

In the third embodiment, two light guide plates 11 are inserted from above into the fastener frame 25 of the mirror element 21 in front of the drive mechanism 23 inside the housing 22. A light source 10 is attached at the top part of each light guide plate 11. The light guide plates 11 overlap longitudinally with the rear light guide plate 11 also functioning as a mirror element; no specific mirror element 21 is provided.

The mirror unit 20 according to the third embodiment of the present invention superposes two light guide plates 11 so that the sheet-like portions thereof are parallel; this mirror unit 20 has no specific mirror element 21. A metal-plated or vapor-deposited reflective layer 18 may be formed as a metal-plated or vapor-deposited layer produced on the rear surface of the rear light guide plate 11 by plating or depositing a metal such as aluminum or silver. Consequently, when external light enters from the emission surface 13 of the front light guide plate 11, the external light reflects from the reflective layer 18 of the rear light guide plate 11 and therefore the rear light guide plate 11 acts as a mirror element.

Light emitted from a light source 10 enters the light guide plate 11. The light guide plate 11 guides the incident light entering from the light source 10 so that the light is repeatedly totally reflected between the emission surface 13 on the rear surface 14 as the 11; the light is reflected from the light focusing portions 15, and exits from the emission surface 13. The light emitted from the light emission surface 13 of the light guide plate 11 forms an image outside the mirror unit 20 and produces a stereoscopic image presenting a direction such as an arrow. That is, the light guide plate 11 is provided with a plurality of light focusing portions 15 which change the path of incidence light from the light source 10 toward the emission surface 13 causing the light output to converge toward a convergence point P or convergence line outside the mirror unit 20 or to radiate from a convergence point P or convergence line outside the mirror unit 20 and thereby form an image externally. Hereby, each of the light guide plates 11 may produce different images when light is emitted from the light source 10 and can present images such an arrow showing a direction. Additionally, the image 17 resulting from image formation does not pass through a reflective layer 21c such as the type in the mirror element 21 according to the second embodiment, and thus allows the display device 1 according to the third embodiment to present a bright image 17.

Furthermore, the light guide plate 11 situated at the rear includes a reflective layer 18 formed on the rear surface 14 which is at the rear part facing the emission surface 13 which is the surface at the front. External light entering the light guide plate 11 from the emission surface 13 and passing through the front light guide plate 11 and the rear light guide plate 11 is reflected by the reflective layer 18. The external light that reflects from the reflective layer 18 exits from the emission surface 13, passes through the front light guide plate 11, and exits through the emission surface 13 of the front light guide plate 11. The rear light guide plate 11 may thus act as a mirror. Note that although the light reflected from the rear light guide plate 11 passes through the front light guide plate 11, the distortion of the image reflected from the portion acting as a mirror may be more controlled passing through a single light guide plate 11 compared to when the light must pass through two light guide plates 11.

The third embodiment thusly configured uses a display device 1 provided with two light guide plates 11 in a mirror unit 20 to present a stereoscopic image in accordance with an external signal, the stereoscopic image oriented towards the front or rear i.e., an actual direction, and in other words an arrow representing the direction responses to the location of an obstacle such as another vehicle that is approaching. Additionally, having the rear light guide plate 11 include a reflective layer 18 that acts as a mirror allows the light guide plate 11 to form light that presents a bright image 17. Given that the light reflected from the rear light guide plate 11 passes through the front light guide plate 11, the distortion of the image reflected from the portion acting as a mirror may be more controlled compared to when the light must pass through two light guide plates 11.

### Fourth Embodiment

The fourth embodiment provides a layer for protecting an outer surface of the rear light guide plate 11 of the third embodiment. Given that only a layer is added in the fourth embodiment and all other configurations are identical to the third embodiment, it is sufficient to reference the third embodiment for these configurations as further descriptions thereof are omitted. The identical parts in the third and fourth embodiments are given the same reference numerals.

FIG. 18 is a schematic view illustrating an example of an optical path in a display device provided to the mirror unit 20 according to a fourth embodiment of the present invention. FIG. 18 superimposes a schematic cross-sectional view of the display device 1 according to the fourth embodiment; here, solid and dotted arrows represents the optical path of light emitted from the light source 10, while double lines represent the path of external light entering from outside.

In the fourth embodiment, two light guide plates 11 are inserted from above into the fastener frame 25 of the mirror element 21 in front of the drive mechanism 23 inside the housing 22. A light source 10 is attached at the top part of each light guide plate 11. The light guide plates 11 overlap longitudinally with a layer formed on the back surface of the rear light guide plate 11 to protect this back surface. The layer is produced from stacking metal-plate or vapor deposited reflective layer 18 formed by metal plating or vapor-depositing a metal such as aluminum or silver on top of a transmissive layer 19 produced from a resin material such as a transparent polycarbonate resin or a poly methyl methacrylate resin. The transmissive layer 19 is integrally molded via heat treatment or the like to the flat portions of the rear light guide plate 11 with no light focusing portions 15. Therefore, the transmissive layer 19 and the reflective layer 18 having a protective layer function as a mirror element since the external light that enters the emission surface 13 from the light guide plate 11 passes through the two superposed light guide plates 11, further passes through the transmissive layer 19 and reflects from the reflective layer 18.

Light emitted from a light source 10 enters the light guide plate 11 from above. The light guide plate 11 guides the incident light entering from the light source 10 so that the light is repeatedly totally reflected between the emission surface 13 on the rear surface 14 as the 11; the light is reflected from the light focusing portions 15, and exits from the emission surface 13. The light emitted from the light emission surface 13 of the light guide plate 11 forms an image outside the mirror unit 20 and produces a stereoscopic image presenting a direction such as an arrow. That is, the light guide plate 11 is provided with a plurality of light focusing portions 15 which change the path of incidence light from the light source 10 toward the emission surface 13 causing the light output to converge toward a convergence point P or convergence line outside the mirror unit 20 or to radiate from a convergence point P or convergence line outside the mirror unit 20 and thereby form an image externally. Hereby, each of the light guide plates 11 may produce different images when light is emitted from the light source 10 and can present images such an arrow showing a direction. Additionally, the image 17 resulting from image formation does not pass through a reflective layer 21c such as the type in the mirror element 21 according to the first embodiment, and thus allows the display device 1 according to the fourth embodiment to present a bright image 17. Moreover, the rear light guide plate 11 is not affected by the reflective layer 18 since no reflective layer 18 is formed at the notched portions of the light guide plate 11 that create the light focusing portions 15; consequently, a display device 1 according to the embodiment can present an even brighter image 17 than the display device 1 of the third embodiment.

A light guide plate 11 thusly situated at the rear includes a transmissive layer 19 on the rear surface 14 at the rear part facing the emission surface 13, and a reflective layer 18. The transmissive layer 19 allows external light entering from the emission surface 13 of the superposed light guide plate 11 to pass therethrough, and the reflective layer 18 reflects the external light that passed through the transmissive layer 19 toward the emission surface 13. The external light that reflects from the reflective layer 18 passes through the transmissive layer 19, passes through the superposed light guide plate 11, and exits through the emission surface 13 of the front light guide plate 11. The transmissive layer 19 thus acts as a mirror.

The fourth embodiment thusly configured uses a display device 1 provided with two light guide plates 11 with a transmissive layer 19 and a reflective layer 18 formed on the rear light guide plate 11 in a mirror unit 20 to present a stereoscopic image in accordance with an external signal, the stereoscopic image oriented towards the front or rear i.e., an actual direction, and in other words an arrow representing the direction responses to the location of an obstacle such as another vehicle that is approaching. Additionally, forming a transmissive layer 19 and a reflective layer 18 that function as the mirror element 21 allows the light guide plate 11 to form light that presents a bright image 17 produced via formation.

### Fifth Embodiment

The fifth embodiment uses a single light guide plate 11 of the first embodiment as the display device 1 provided to the mirror unit 20 and the single light guide plate 11 is used to form a plurality of different images 17. Given that only the light guide plate 11 and the light source 10 are different in the embodiment and all other configurations are identical to the first embodiment, it is sufficient to reference the first embodiment for these configurations as further descriptions thereof are omitted. The identical parts in the first and fifth embodiments are given the same reference numerals.

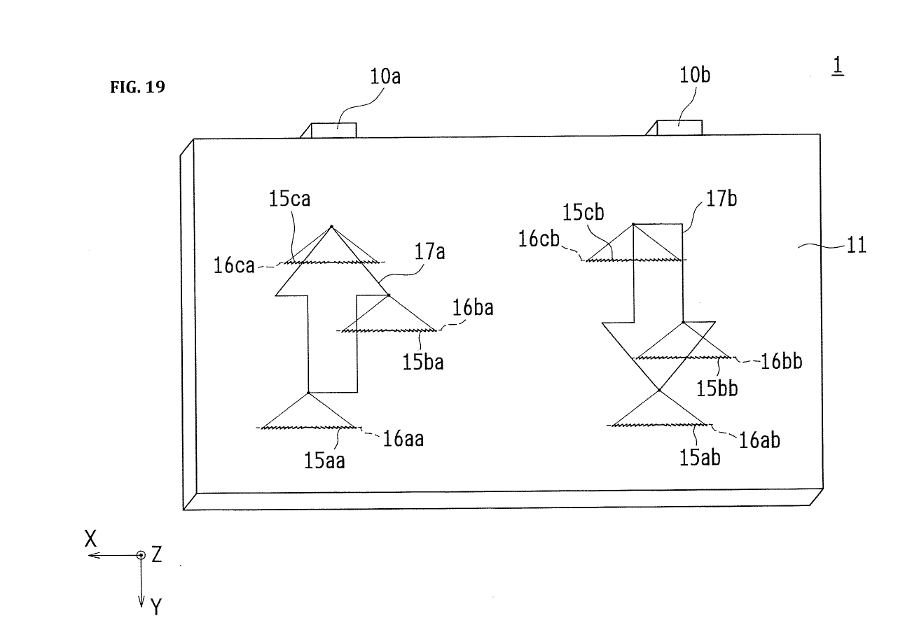

FIG. 19 is for describing a display device 1 according to a fifth embodiment of the present invention and schematically illustrates the display device 1 along with an image formed in a space. FIG. 9 schematically illustrates the display device 1 according to the fifth embodiment. The display device 1 according to the fifth embodiment is provided with a single light guide plate 11, a first light source 10a and a second light source 10b. The light guide plate 11 includes first light focusing group which includes a plurality of light focusing portions 15 depicted as light focusing portions 15aa, 15ba, 15ca, . . . and a second light focusing group which includes a plurality of light focusing portions 15 depicted as light focusing portions 15ab, 15bb, 15cb, . . . . The light focusing portions 15aa, 15ba, 15ca, . . . are each formed along lines 16aa, 16ba, 16ca, . . . ; and the light focusing portions 15ab, 15bb, 15cb, . . . are each formed along lines 16ab, 16bb, 16cb, . . . .

The light emitted from the first light source 10a enters the light guide plate 11; the first light focusing group including the plurality of light focusing portions 15 depicted as light focusing portions 15aa, 15ba, 15ca, . . . changes the path of the light so the light produces a first image 17a. The light emitted from the second light source 10b enters the light guide plate 11; the second light focusing group including the plurality of light focusing portions 15 depicted as light focusing portions 15ab, 15bb, 15cc, . . . changes the path of the light so the light produces a second image 17b. That is, the first image 17a is shown when the first light source 10a emits light, and the second image 17b is shown when the second light source 10b emits light.

The light emitted from the first light source 10a and the second light source 10b may be narrowed to increase directivity to consequently prevent light emitted by the first light source 10a entering the second light focusing group, for example. Even if the light emitted by the first light source 10a were to enter the second light focusing group, the light would not create an image in a direction perceivable from the driver's seat and thus prevents mutual interference by the light sources. The light emitted by the second light source 10b behaves identically.

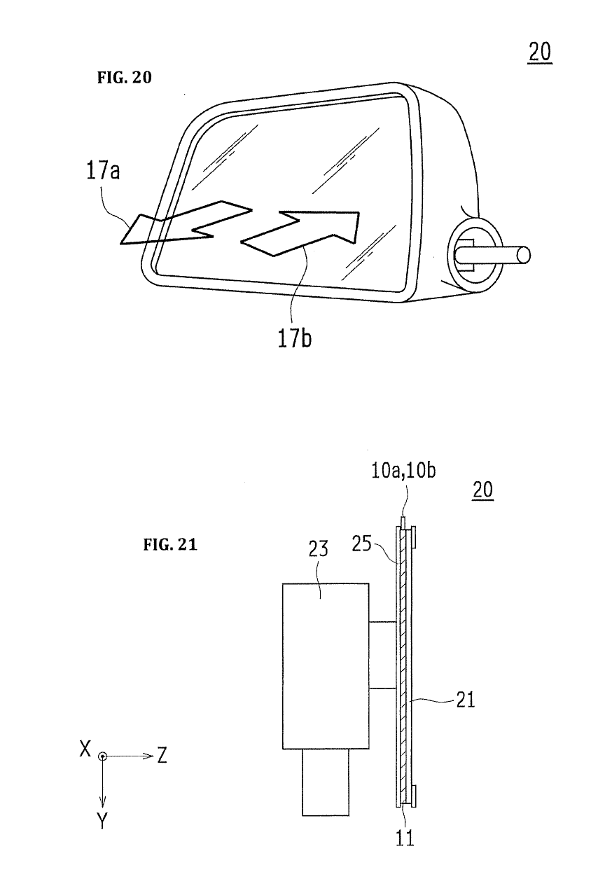

FIG. 20 is a schematic perspective view illustrating an example of the external features of a mirror unit 20 according to the fifth embodiment of the present invention and an image presented thereby. The mirror unit 20 depicted in FIG. 20 forms the light to show different images, i.e., a first image 17a and a second image 17b. The mirror unit 20 depicted in FIG. 20 shows a first image 17a of a rearward arrow when the first light source 10a emits light, and shows a second image 17b of a forward arrow when the second light source 10b emits light.

FIG. 21 is a schematic cross-sectional view illustrating an example of the internal structure of the mirror unit 20 according to the fifth embodiment of the present invention. The mirror unit 20 according to the fifth embodiment includes a fastener frame 25 secured to a drive mechanism 23 with the light guide plate 11 and the mirror element 21 stored in the fastener frame 25. A single light guide plate 11 is arranged behind the mirror element 21 in the fastener frame 25 with a first light source 10a and a second light source 10b attached at the top part of the light guide plate 11.

In this manner, the mirror unit 20 according to the fifth embodiment is provided with a single light guide plate 11 with a plurality of light sources attached thereto, in this case, a first light source 10a and a second light source 10b. The light guide plate 11 further includes a first light focusing group that changes the optical path of light emitted from the first light source 10a and forms the light to show a first image 17a, and a second light focusing group that changes the optical path of light emitted from the second light source 10b and forms the light to show a second image 17b. Therefore, the first image 17a is shown when the first light source 10a emits light, and the second image 17b is shown when the second light source 10b emits light. Accordingly, a plurality of different images 17 can be shown via a single light guide plate 11.

### Sixth Embodiment

The sixth embodiment switches the locations of the light guide plate 11 and the mirror element 21 of the fifth embodiment. Given that only the location of the light guide plate 11 and the mirror element 21 changes in the sixth embodiment and all other configurations are identical to the fifth embodiment, it is sufficient to reference the fifth embodiment for these configurations as further descriptions thereof are omitted. The identical parts in the fifth and sixth embodiments are given the same reference numerals.

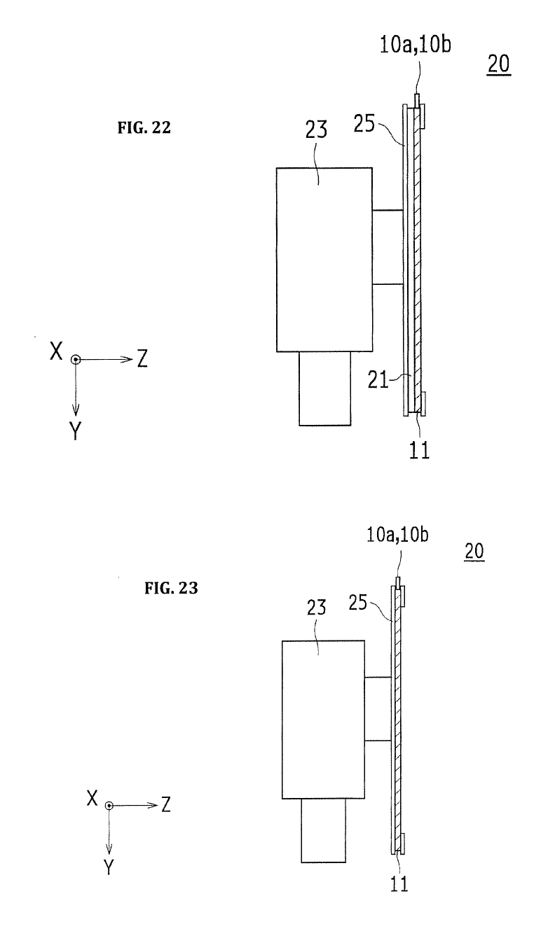

FIG. 22 is a schematic cross-sectional view illustrating an example of the internal structure of a mirror unit 20 according to a sixth embodiment of the present invention. The mirror unit 20 according to the sixth embodiment includes a fastener frame 25 secured to a drive mechanism 23 with the light guide plate 11 and the mirror element 21 stored in the fastener frame 25. A single light guide plate 11 is arranged in front of the mirror element 21 in the fastener frame 25 with a first light source 10a and a second light source 10b attached at the top part of the light guide plate 11.

Thus, the mirror unit 20 according to the sixth embodiment of the present invention can present a plurality of different images with a single light guide plate 11.

### Seventh Embodiment

The seventh embodiment uses the light guide plate 11 in the display device 1 provided to the mirror unit 20 as a mirror element 21. Given that only the light guide plate 11 and the mirror element 21 are different in the seventh embodiment and all other configurations are identical to the fifth embodiment, it is sufficient to reference the fifth embodiment for these configurations as further descriptions thereof are omitted. The identical parts in the fifth and seventh embodiments are given the same reference numerals.

FIG. 23 is a schematic cross-sectional view illustrating an example of the internal structure of a mirror unit 20 according to a seventh embodiment of the present invention. The mirror unit 20 according to the seventh embodiment includes a fastener frame 25 secured to a drive mechanism 23 with the light guide plate 11 and the mirror element 21 stored in the fastener frame 25. The first light source 10a and the second light source 10b are attached at the top part of the light guide plate 11. The light guide plate 11 also acts as a mirror element; no specific mirror element 21 is provided. The descriptions of the third and fourth embodiments may be referenced regarding a light guide plate 11 that also acts as the mirror element; the description is not repeated here.

Thus, the mirror unit 20 according to the seventh embodiment of the present invention can present a plurality of different images with a single light guide plate 11.

The present invention is not limited to the above described embodiments and may be implemented in various other ways. Therefore, in all respects the above embodiments are merely example and should not be interpreted as limitations. The scope of the present invention is delineated by the claims and not limited by the specification.

Moreover, all modifications and variations with a scope equivalent to the claims are within the scope of the present invention.

For example, the aforementioned first through fourth embodiments use two superposed light guide plates 11; the present invention is not limited thereto, and may use a single light guide plate 11 or three or more light guide plates 11 to produce the stereoscopic image. In addition, all the light guide plates 11 do not need to be configured to output light toward a driver (assumed to be the observer) when there is a plurality of light guide plates 11. More specifically, two light guide plates 11 may be superposed to create an image indicating a directing while assuming the driver is to be the observer; moreover, another light guide plate 11 may be superposed thereon to output light toward an observer assumed to be the driver of a following vehicle. A light source 10 that also operates a direction signal indicator (turn signal indicator) on the vehicle 2 may also be attached to the light guide plate 11 that outputs light toward the direction of an observer assumed to be the driver of the following vehicle. This light guide plate 11 may output light whenever the vehicle 2 turns left or right or changes course. In this case, the driver of the following vehicle is taken as the observer, and therefore a stereoscopic image does not necessarily need to be presented. Therefore, a reflection surface formed in this light guide plate 11 may pursue a parallel optical path where the light travels in the same direction since there is no need for the light guide plate 11 to focus the light output. A mirror unit 20 having a light guide plate 11 thusly configured can show a direction-indicative stereoscopic image which a driver of the vehicle 2 provided with the mirror unit can see, and the driver of the following vehicle can see the light emitted from the mirror element 21 indicating a change of course. This kind of configuration may be applied to the third or fourth embodiments. In this case, layers such as the transmissive layer 19 and the reflective layer 18 may be formed on the surface at the rear side of another light guide plate 11 when the other light guide plate 11 is situated behind a light guide plate 11 that forms the stereoscopic image.

Moreover, the fifth through seventh embodiments may be configured with three or more light sources 10 to allow the same to show three or more images. It is also possible to stack a plurality of light guide plates 11 provided with a plurality of light sources 10 and which show a plurality of images.

While the aforementioned embodiments are provided for installation in a door mirror, the present invention is not limited thereto, and may be mounted to various kinds of mirrors such as a vehicle rear-view mirror.

Finally, while the aforementioned embodiments are provided to display an arrow indicating a direction, the present invention is not limited thereto. Various embodiments may be developed, such as presenting an image that indicates direction via a technique other than showing an arrow, or presenting an image 17 indicating information other than directional information.

1. A mirror unit configured to be installed on a vehicle, comprising:
a mirror element configured to reflect external light entering from a front surface toward the front surface; and
a display device configured to show an image,
wherein the display device comprises:
a light source configured to emit light, and
a light guide element configured to guide incident light from the light source,
wherein the light guide element comprises:
an emission surface configured to output incident light, and
a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element, and
wherein the mirror element and the light guide element are arranged so that the light focusing portions form an image near the front surface of the mirror element.

2. The mirror unit according to claim 1, wherein the light guide element is panel-like and is superposed on the mirror element at the front surface of the mirror element.

3. The mirror unit according to claim 1,
wherein the mirror element comprises:
a thin-film transmissive portion configured with one surface as a front surface, and
a reflective layer formed on the other surface of the transmissive portion and configured to reflect external light entering from the front surface and passing through the transmissive portion, and
wherein the light guide element is arranged at the other surface of the mirror element.

4. A mirror unit configured to be installed on a vehicle, comprising:
a display device configured to show an image, comprising:
a light source configured to emit light; and
a panel-like light guide element configured to guide incident light from the light source, and comprising:
an emission surface configured to output incident light, and
a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element; and
a reflective layer formed on the surface facing the emission surface of the light guide element and configured to reflect external light entering from the emission surface and passing through the light guide element toward the emission surface.

5. A mirror unit configured to be installed on a vehicle, comprising:
a display device configured to show an image, and comprising:
a light source configured to emit light, and
a panel-like light guide element configured to guide incident light from the light source, and comprising:
an emission surface configured to output incident light from the light source, and
a plurality of light focusing portions configured to change the path of the incident light toward the emission surface, causing the light output to converge toward a convergence point or convergence line outside the light guide element or to radiate from a convergence point or convergence line outside the light guide element and thereby form an image outside the light guide element;
a transmissive layer formed on the surface facing the emission surface of the light guide element and configured to allow external light entering from the emission surface and passing through the light guide element to pass therethrough; and
a reflective layer configured to reflect external light passing through the transmissive layer toward the emission surface.

6. The mirror unit according to claim 1, wherein the light focusing portions are configured to form light showing an image that spreads in a direction other than a direction parallel to the emission surface.

7. The mirror unit according to claim 1, wherein the light focusing portions are configured to form light showing an image that indicates direction.

8. The mirror unit according to claim 1,
wherein the mirror unit is provided with a plurality of light guide elements; and
wherein each of the light guide elements forms light showing a different image.

9. The mirror unit according to claim 1,
wherein the mirror unit is provided with a plurality of light guide elements; and
wherein each of the light guide elements forms light showing an image indicating a different direction.

10. The mirror unit according to claim 1,
wherein a single light guide element is configured with a plurality of light sources that emit light, and
wherein the plurality of light focusing portions in the light guide element comprises:
a first light focusing group that changes the optical path of light emitted from a first light source and forms light to show a first image, and
a second light focusing group that changes the optical path of light emitted from a second light source and forms light to show a second image.

11. The mirror unit according to claim 10, wherein the first light focusing group and the second light focusing group each forms light showing a different image.

12. The mirror unit according to claim 10, wherein the first light focusing group and the second light focusing group each forms light showing an image indicating a different direction.

13. The mirror unit according to claim 2, wherein the light focusing portions are configured to form light showing an image that spreads in a direction other than a direction parallel to the emission surface.

14. The mirror unit according to claim 3, wherein the light focusing portions are configured to form light showing an image that spreads in a direction other than a direction parallel to the emission surface.

15. The mirror unit according to claim 4, wherein the light focusing portions are configured to form light showing an image that spreads in a direction other than a direction parallel to the emission surface.

16. The mirror unit according to claim 5, wherein the light focusing portions are configured to form light showing an image that spreads in a direction other than a direction parallel to the emission surface.

17. The mirror unit according to claim 2, wherein the light focusing portions are configured to form light showing an image that indicates direction.

18. The mirror unit according to claim 3, wherein the light focusing portions are configured to form light showing an image that indicates direction.

19. The mirror unit according to claim 4, wherein the light focusing portions are configured to form light showing an image that indicates direction.

20. The mirror unit according to claim 5, wherein the light focusing portions are configured to form light showing an image that indicates direction.
